(19) United States
(12) Patent Application Publication
(10) Pub. No.: US 2021/0197649 A1
(43) Pub. Date: Jul. 1, 2021

(54) HOUSING TO BE MOUNTED ON A MOTOR VEHICLE DOOR, AND DOOR COMPRISING SUCH A HOUSING

(71) Applicant: Valeo Systemes Thermiques, Le Mesnil-Saint-Denis (FR)

(72) Inventors: Thierry Petit, Le Mesnil Saint Denis (FR); Bruno Demory, Le Mesnil Saint Denis (FR); Yves Rousseau, Le Mesnil Saint Denis (FR)

(73) Assignee: Valeo Systemes Thermiques, Le Mesnil-Saint-Denis (FR)

(21) Appl. No.: 17/058,048

(22) PCT Filed: Jun. 11, 2019
(86) PCT No.: PCT/FR2019/051397

§ 371 Date: Nov. 23, 2020

(30) Foreign Application Priority Data
Jun. 14, 2018 (FR) 1855228
Jun. 14, 2018 (FR) 1855229

(51) Int. Cl. B60H 1/24; B60J 5/04

(52) U.S. Cl. CPC B60H 1/243; B60J 5/0468; B60J 5/0412

(57) ABSTRACT

A housing (30) to be mounted on a motor vehicle door (4) is disclosed. The housing includes a first air inlet (35) for admitting a first air stream (FR) into the housing (30), an air outlet (36), a chamber (37), delimited by at least one partition (38), arranged inside the housing (30), a second air inlet (39) for directly admitting a second air stream (FE) into the chamber (37), the first air inlet (35), the chamber (37) and the air outlet (36) being fluidically connected. According to the invention, the housing (30) comprises at least one movable flap (64, 74, 78). Also disclosed is an assembly of a door (4), comprising a housing support (61), and of such a housing (30).

The present invention relates to a housing intended to be mounted on a motor vehicle door. This housing is part of an air distribution device for a vehicle of the motor vehicle type.

Generally, a motor vehicle is equipped with a heating, ventilation and/or air conditioning system that makes it possible to thermally treat the air and then send it into the passenger compartment of the vehicle. The heating, ventilation and/or air conditioning system is configured to reach a thermal comfort setpoint fulfilling a request from a user, and for example a given temperature of the air present in one zone or another of the passenger compartment of the vehicle. To do this, the heating, ventilation and/or air conditioning system draws in outside air and/or air from the passenger compartment and then treats it by passing it successively through heat exchangers, in particular so that it reaches determined ventilation speed and/or temperature conditions that make it possible to approach the thermal comfort setpoint. The treated air is then projected into the passenger compartment by means of air vents disposed so as to supply a particular zone of the passenger compartment with treated air. Depending on whether it is desired to supply the front seats or the rear seats with treated air, these air vents may be disposed in the dashboard, the central console or the lateral uprights of the vehicle.

The heating, ventilation and/or air conditioning system is caused to treat a significant amount of air before reaching the thermal comfort setpoint. However, nowadays users require this thermal comfort setpoint to be reached more rapidly, without reducing the quality of the air in the passenger compartment. Motor vehicle manufacturers and equipment fitters must then propose heating, ventilation and/or air conditioning systems that fulfill these requirements, without this generating excessively high costs, while still having a system that is compact, lightweight and easy to install. Another constraint is the standardization of vehicles, wherein the manufacturers have to be able to adapt to the needs of the consumer and to implement or not implement such a system depending on the wishes of the purchaser of the vehicle. Finally, a second constraint is that the system must be able to adapt to the needs of the vehicle occupants, namely to be able to emit or not emit air streams in certain specific regions of the passenger compartment.

The aim of the present invention is therefore to provide a solution for improving both the distribution of the air and the thermal comfort in the passenger compartment, without oversizing the heating, ventilation and/or air conditioning system, which may be easily mounted or removed, and which can easily guarantee management of the air stream by orienting it towards different regions of the passenger compartment.

In this context, one subject of the invention is a housing, in particular a removable housing, intended to be mounted on a motor vehicle door comprising
a chamber, delimited by at least one wall, arranged inside the housing,
a first air inlet for directly admitting a first air stream into the chamber,
a second air inlet for admitting a second air stream into the housing,
an air outlet, the second air inlet, the chamber and the air outlet being fluidically connected.

According to the invention, the housing comprises at least one movable flap.

Thus, the invention allows the two air streams to mix, this ensuring better blending of the air in the passenger compartment, thus improving user comfort. Specifically, by increasing the amount of blended air, the thermal mixing between the various air streams takes place more rapidly. The housing corresponds to an element which can easily be handled and easily installed in or removed from a vehicle door, wherein because of its inclination, the movable flap allows the air stream to flow or not flow, and also orients the air stream towards certain regions of the passenger compartment of the vehicle depending on its position and degree of inclination, in order to achieve the thermal comfort desired by the vehicle's occupants.

According to one or more features of the invention, which may be taken alone or in combination, it may be provided that:
the chamber comprises a blading extending inside the chamber;
the housing has a curved shape;
a duct is connected to the second air inlet for directly admitting the second air stream into the chamber, the second air stream coming from a heating, ventilation and/or air conditioning system;
the duct comprises bellows which guarantee the air-tightness of the duct at the door;
the chamber has an oblong-shaped cross-section;
a channel for the at least partial flow of the first and second air streams extends from the first air inlet to the air outlet and is delimited by the walls of the housing and said at least one partition of the chamber;
the chamber opens into the channel via a contraction;
the housing comprises a first part, a chamber corresponding to the delivery of the second treated air stream coming from the heating, ventilation and/or air conditioning system, this chamber opening into a second part of the housing arranged outside the chamber via a contraction;
the contraction extends along the entire length of the chamber, in a direction followed by the treated air stream into the opening of the second air inlet or into the delivery duct connected to this second air inlet;
the housing comprises a mixing zone in which the second treated air stream coming from the heating, ventilation and/or air conditioning system, and the first air stream coming from the passenger compartment, are intended to mix by lapping the partition forming the chamber along a trajectory tangential to this partition;
a first movable flap is arranged at the level of the air outlet;
the first flap is of the shutter or butterfly type comprising at least one panel and a rotation shaft;
the first flap comprises a first set of flaps and a second set of flaps, the flaps of the first set of flaps pivoting in one direction of rotation and the flaps of the second set of flaps pivoting in the opposite direction of rotation;
the first flap is of the sliding type comprising at least one sliding door inside a rail;
a third movable flap is arranged at the level of the first air inlet;
the third movable flap comprises a sliding door inside a rail;
a fourth movable flap is arranged at the level of the second air inlet;
a third movable flap is arranged at the level of the first air inlet, and a fourth movable flap is arranged at the level of the second air inlet.

The invention also relates to an assembly of a vehicle door, comprising a support for a housing, and of a housing as described above.

According to one or more features of the invention, which may be taken alone or in combination, it may be provided that:
the door comprises at least one trim panel and a door bodywork together forming the door, said trim panel and the door bodywork defining between them a hollow body via which the air stream may flow, a second movable flap being arranged inside the hollow body;
the second movable flap is of the shutter or butterfly type comprising at least one panel and a rotation shaft;
the hollow body comprises at least two outlet openings, the second movable flap being arranged between said outlet openings such that the air stream can be selectively oriented towards at least one of said outlet openings.

The invention also concerns an assembly of a vehicle door, comprising at least one trim panel and a door bodywork together forming the door, said trim panel and the door bodywork defining between them a hollow body via which an air stream may flow, and comprising a housing support, and of a housing comprising:
a first air inlet for admitting a first air stream into the housing,
an air outlet,
a chamber, delimited by at least one partition, arranged inside the housing,
a second air inlet for directly admitting a second air stream into the chamber, the first air inlet, the chamber and the air outlet being fluidically connected.

According to the invention, a movable flap is arranged inside the hollow body.

Further features, details and advantages of the invention will emerge upon reading the description given below by way of indication with reference to drawings, in which:

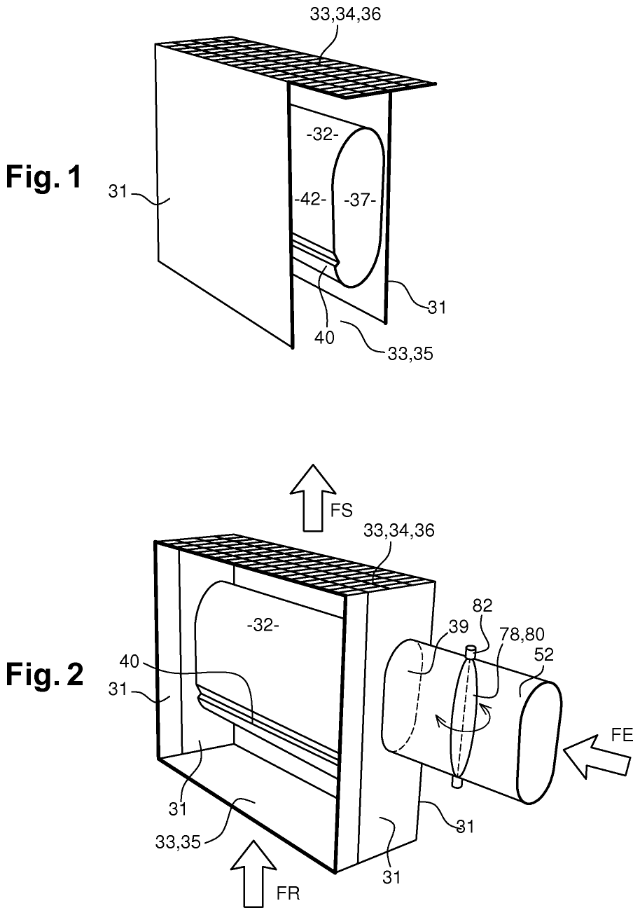

FIG. 1 is a perspective depiction of a part of the housing according to the invention,

FIG. 2 is a perspective depiction of the housing according to one embodiment of the invention,

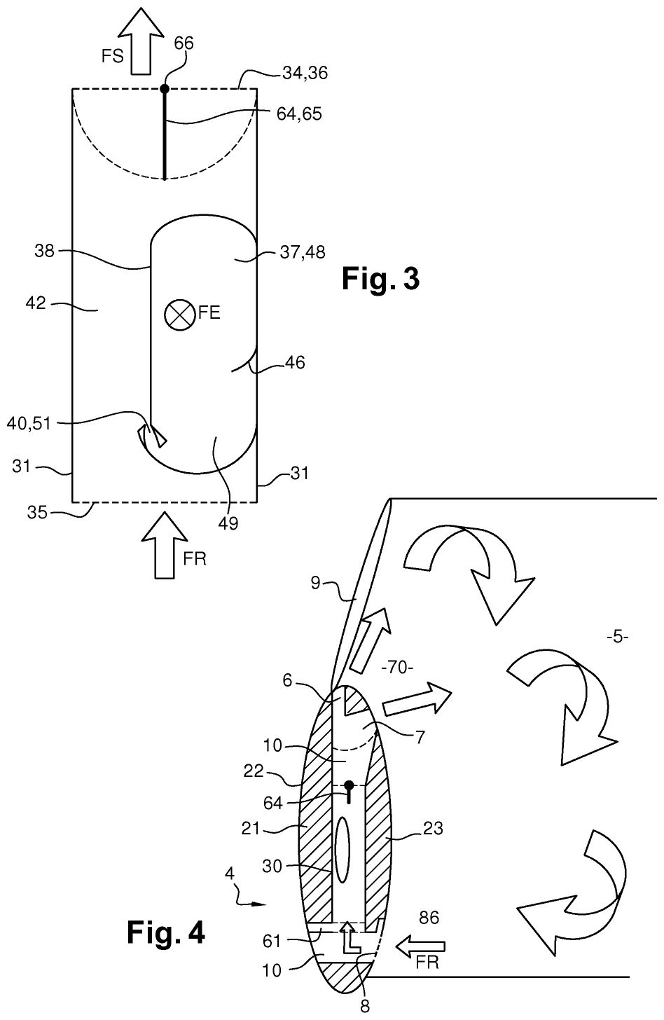

FIG. 3 is a schematic, sectional depiction of the housing according to one embodiment of the invention,

FIG. 4 is a schematic, partial sectional depiction of a motor vehicle passenger compartment, and of a door of the vehicle comprising a housing according to an exemplary embodiment of the present invention,

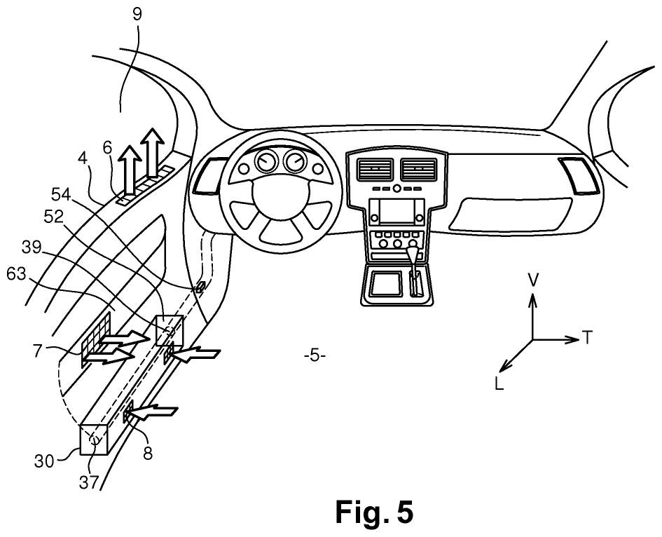

FIG. 5 is a schematic perspective depiction of a part of the passenger compartment of the motor vehicle and of the door comprising the housing.

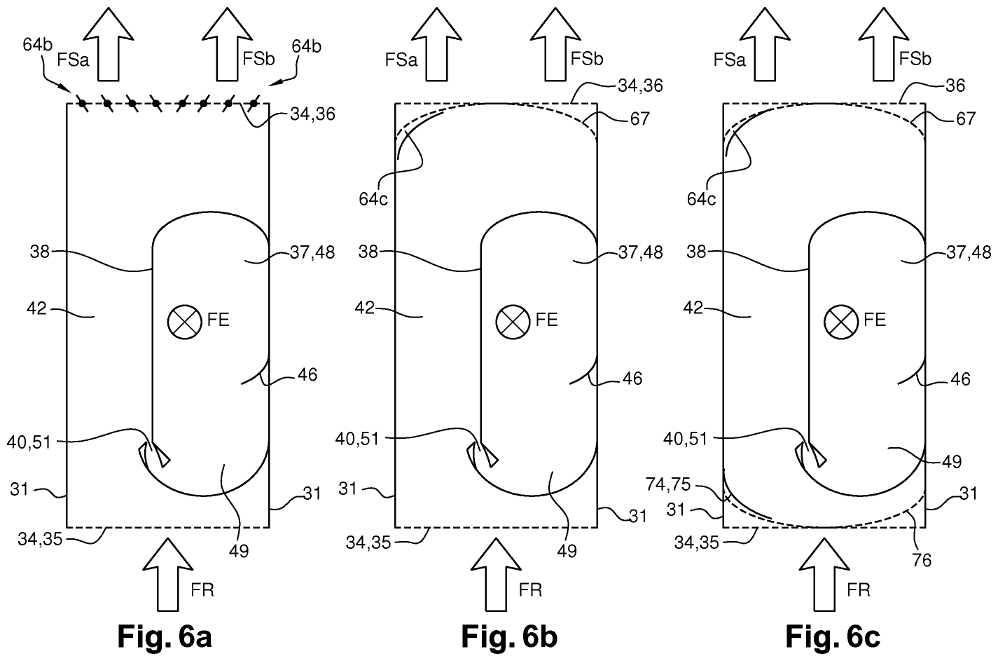

FIG. 6a is a schematic, sectional depiction of the housing according to another embodiment of the invention,

FIG. 6b is a schematic, sectional depiction of the housing according to another embodiment of the invention,

FIG. 7 is a schematic, partial sectional depiction of a motor vehicle passenger compartment and of a door of the vehicle comprising a housing according to an exemplary embodiment of the present invention,

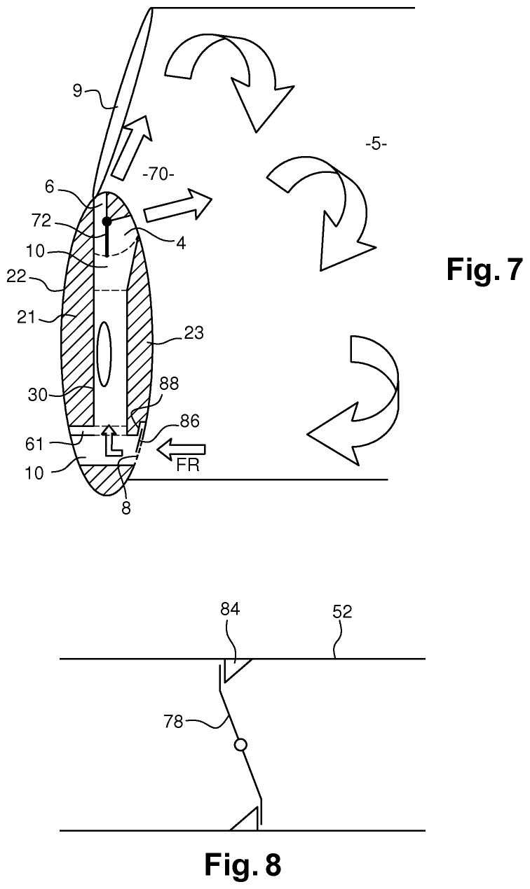

FIG. 8 is a schematic sectional depiction of the duct connected to the second air inlet.

It should first of all be noted that the figures set out the invention in a detailed manner in order to implement the invention, it being, of course, possible for said figures to serve to better define the invention if necessary.

In the following description, relative concepts such as “internal”, “external”, “upper”, “lower”, “front” or “rear” are defined with respect to a passenger compartment of the motor vehicle and to the vehicle itself. The concept of “internal” according to this frame of reference means that the element in question is situated or directed toward the passenger compartment, while the concept of “external” according to this frame of reference means that the element in question is situated or directed toward the outside of the motor vehicle, moving away from the passenger compartment. The concept of “upper” according to this frame of reference means that the element in question is situated or directed toward the roof of the motor vehicle, while the concept of “lower” according to this frame of reference means that the element in question is situated or directed toward the floor of the motor vehicle. A longitudinal axis L is defined as the axis along which the motor vehicle extends along its length, the longitudinal axis L being parallel to an axis of forward movement of the motor vehicle when the latter is running. In the following description, reference will also be made to an orientation as a function of a vertical axis V, defined as being the axis perpendicular to the floor of the vehicle when the latter is running, and of a transverse axis T, defined as being the axis perpendicular to both the longitudinal axis L and the transverse axis T. It will therefore be appreciated that the concepts of “internal” and “external” are understood along the transverse axis T, the concepts of “upper” and “lower” are understood along the vertical axis V and the concepts of “front” and “rear” are understood relative to the longitudinal axis L, the “front” of the vehicle being defined as the part of the vehicle in front of the driver under running conditions and the “rear” being the part situated behind the backrest of the driver's seat. The terms “upstream” and “downstream” are defined with respect to the flow of a stream of air.

FIGS. 1 and 2 illustrate a housing 30 according to the present invention. The housing is defined by a set of walls 31, in this case four, arranged so as to define an internal volume 32, or internal space. As illustrated in FIGS. 1 and 2, the housing 30 corresponds in this case to a rectangular parallelepiped with four contiguous walls 31 and the two other opposite faces 33 being open or being provided with a grille 34. In other words, the housing 30 therefore comprises four walls 31 that define an internal volume 32, or a cavity, the housing also comprises a first air inlet 35 for allowing a first air stream FR to enter the housing 30 and an air outlet 36 for allowing an air stream FS to leave the housing 30. The housing 30 thus comprises a channel 42 for the flow of the first air stream FR from the first air inlet 35 as far as the air outlet 36.

The housing 30 according to the invention also comprises a chamber 37, delimited by at least one partition 38, arranged inside the housing 30 in the internal volume 32. The housing 30 also comprises a second air inlet 39 for directly admitting a second air stream FE into the chamber 37. The channel 42 corresponds to the internal volume 32 of the housing 30 situated outside the chamber 37, in other words the channel 42 is delimited by the walls 31 of the housing 30 and by said partition 38 of the chamber 37. The chamber 37 has at least one surface that coincides with a wall 31 of the housing 30, the second air inlet 39 being arranged on this surface.

The housing 30 according to the invention is arranged such that the first air inlet 35, the chamber 37 and the air outlet 36 are fluidically connected. In other words, the chamber 37 has an opening 40 arranged so as to allow the second air stream FE to flow out of the chamber 37 and mix with the first air stream FR in the internal volume 32 and the channel 42. In other words, the first air stream FR enters the housing via the air inlet 35 and flows in the housing 30 in the direction of the air outlet 36, the second air stream FE directly enters the chamber 37 and then flows through the opening 40 in the housing 32 into the channel 42. The chamber 37 opens into the channel 42 so as to allow the second air stream FE to mix with the first air stream FR. In other words, the housing 30 comprises a channel 42 for the flow of the first and second air streams FE, FR and extends from the first air inlet 35 as far as the outlet 36, delimited by the walls 31 of the housing 30 and said at least one partition 38 of the chamber 37.

According to the invention, the first air stream FR may for example come from the passenger compartment of the vehicle, while the second air stream FE may for example come from a heating, ventilation and/or air conditioning system (not shown) situated upstream of the housing. In order to fulfill a request from a user regarding the thermal comfort setpoint of the passenger compartment 5, the temperature of the second treated air stream FE may vary, in particular between hot, cold and temperate, and the speed of the second treated air stream FE may be varied by changing the speed of the fan of the heating, ventilation and/or air conditioning system. The housing 30 according to the invention allows the air in the passenger compartment 5 to mix with treated air coming from the heating, ventilation and/or air conditioning system, this ensuring better blending of the air in the passenger compartment, thus improving user comfort, by ensuring that the air in the passenger compartment is renewed and by reaching a thermal comfort setpoint more rapidly. Specifically, by increasing the amount of blended air, the thermal mixing between the various air streams takes place more rapidly.

In order to allow better mixing between the two air streams FE, FR, the chamber 37 the chamber comprises a blading 46 extending in its internal space. This blading 46 corresponds to an internal partition, in other words a rib, gutter, protuberance or protrusion, that extends partially inside the chamber 37. The blading 46 has the shape of a quarter circle and diverts the trajectory of the second air stream FE, thus inducing turbulence. The second air stream FE enters the chamber 37 via the second air inlet 39 in the upper part 48 of the chamber 37 situated above the blading 46. Said air stream FE is then oriented toward the opening 40 so as to be able to open into the channel 42, the opening being arranged in the lower part 49 of the chamber situated below the blading 46.

As illustrated in FIG. 3, the chamber 37 opens into the channel 42 via a contraction 51. In other words, the chamber 37 has an opening 40 allowing the second air stream FE to flow from the chamber 37 into the channel 42. This opening 40, extending over the entire length of the partition 38, comprises a contraction 51 of the flow cross-section so as to create a difference in pressure between the inside of the chamber 37 and the channel 42 outside the chamber 37. Because of the pressure differential, the second air stream FE situated inside the chamber 37 is therefore drawn in the direction of the contraction 51 and then is propelled into the channel 42, where it is mixed with the first air stream FR, and flows as far as the air outlet 36. In other words, the contraction 51 causes a reduction in the flow cross-section that accelerates and increases the flow rate of the second treated air stream FE coming from the heating, ventilation and/or air conditioning system, which then generates a drop in pressure able to draw the first air stream, coming from the passenger compartment, through the first air inlet 35.

As illustrated in FIG. 3, the chamber 37 here has an oblong-shaped cross-section. In other words, the chamber 37 preferably has a cross-section with a shape that is longer than it is wide and of which the corners are rounded. In other words, the planar cross-section of the chamber 37 is oblong-shaped. This shape, in combination with the exit angle of the second air stream FE through the contraction 51, makes it possible to induce a better Coand\check{a} effect, wherein the partition 38 of the chamber 37 corresponds to a Coand\check{a} surface at which the air streams FE and FR are mutually diverted along this partition 38, in particular level with the planar surface and the convex surface (rounded edge), thus improving their mixing.

As illustrated in FIG. 2, the housing 30 comprises a duct 52 connected to the second air inlet 39 for directly admitting the second air stream FE into the chamber 37. The duct 52 is for example connected to the heating, ventilation and/or air conditioning system of the vehicle, thus the second air stream FE coming from the heating, ventilation and/or air conditioning system emerges directly into the chamber 37.

According to one embodiment, the duct 52 comprises bellows 54 as illustrated in FIG. 5. Specifically, the housing 30 is arranged so as to be mounted in a door 4. Since the door will be opened and closed, by arranging a bellows 54, i.e. an element formed by a cavity made of flexible material able to expand in order to fill with air by suction and to empty by compression producing a jet of directed air, a good seal and the prevention of air stream losses are assured.

In order to adapt to the shape of the door, the housing 30 may have a straight or rectilinear shape, or a curved or bent shape.

FIG. 4 shows a motor vehicle passenger compartment 5 in which a housing 30 is incorporated in a door 4, the structure and walls of which form a hollow body 10. The hollow body 1 comprises at least three openings 6, 7, 8 opening into the passenger compartment 5.

FIG. 4 also shows that the door 2 comprises a door bodywork 22, in this case associated with a first trim panel 21 and a second trim panel 23 on the other side. The trim panels 21, 23 are arranged on either side of the housing 30. The trim panels 21, 23 and the door bodywork 22 form between them a hollow body 10, or a channel through which the air stream may flow and in which the housing 30 is arranged. The door bodywork 22 delimits the motor vehicle relative to the outside of the motor vehicle and has one face exposed to the outside of the motor vehicle and one face turned toward the hollow body 10. The door comprises a support means 61 for carrying the housing 30. The support means 61 may correspond to hooks, notches being arranged on the housing 31, a grating on which the housing 30 is placed. The housing 30 may also be held solely by the two trim panels 21, 23.

The trim panels 21, 23 and the door bodywork 22 are at least partially connected by walls extending transversely relative to these faces. More particularly, a first transverse wall is defined supporting the hinge allowing the door 2 to move relative to the vehicle, and a second transverse wall comprising a system for locking the door 2. It will therefore be appreciated that the first transverse wall is situated at the front of the vehicle compared with the second transverse wall that is situated further back in the vehicle, according to the frame of reference defined above.

FIG. 4 makes it possible to distinguish, among the openings 6, 7, 8 of the air distribution device employing a housing 30, a first outlet opening 6 arranged at the bottom of the window 9, a second outlet opening 7 arranged at the level of the armrests 63, and a third air inlet opening 8 arranged in the footwell or on the floor of the passenger compartment 5.

FIG. 5 shows that a plurality of outlet openings 6, 7 opening into the hollow body 10 may be provided. Regarding the disposition of these outlet openings 6, 7 relative to the door 2, a first outlet opening 6 is disposed at the bottom of a window 9 and a second outlet opening 7 is disposed at the level of an armrest or arm support 63 in order to deliver an air stream 70 emitted in the direction of the torso of a user of the vehicle.

In general, each outlet opening 6,7 is situated in an upper part of the door 2 according to the frame of reference defined above. In other words, each outlet opening 7 is situated closer to the roof than to the floor of the motor vehicle. The outlet openings 6, 7 are not coaxial.

According to the invention, the housing 30 comprises at least one movable flap 64, 74, 78. A movable flap corresponds to a wall allowing the air stream to be oriented, or in other words the movable flap corresponds to an element pivoting in one direction of rotation, or to an element sliding in a rail, which to a greater or lesser extent obstructs the flow of an air stream. Depending on its degree of inclination or its position in the rail, the flap may orient the flow of an air stream in various directions. It is thus possible to guarantee management of an air stream by orienting the flow of the air stream towards different regions of the passenger compartment.

There are several types of flaps, wherein the invention is not limited to a single flap type. A butterfly flap corresponds to a flap with a panel or wall pivoting around a rotation axis, the rotation axis being in the centre of the panel. In an alternative, the butterfly flap may also correspond to a flap with two wings and a rotation axis, the rotation axis being situated between the two wings. The term wing or panel, wherein the two terms are equivalent, means a wall or plate which is generally flat and rectangular and made of plastic. The surface of the wing or panel allows diversion of the air stream or even prevents its flow. A shutter flap corresponds to a flap with a wing or panel pivoting around a rotation axis situated at one end of the panel. A drum flap corresponds to a flap comprising two lateral walls lying in two distinct and mutually parallel planes, with a curved wall between them serving to prevent the air stream from passing and connecting the two lateral walls. The curved wall and the rotation shaft form a continuity of material between the two lateral walls. Each rotation axis corresponds to a rotation shaft serving to induce the rotational movement via an actuator. A sliding flap (better known as a sliding door), corresponds to a flap comprising a sliding door or panel (the two terms being equivalent) inside a rail, and on which at least one rack is arranged. In order to set the door in motion, at least one additional gearwheel complementary to the rack is set in rotation about an axis via an actuator. Rotation of the gearwheel causes the translational movement of the sliding door along the rail.

According to the invention, the housing 30 comprises a first flap 64 arranged at the level of the air outlet 36. The first flap 64 may be of the butterfly, shutter, sliding door or drum type. As illustrated on FIG. 3, the first flap 64 is here of the shutter type. The first flap 64 comprises a wall 65 and a rotation shaft 66 arranged at one end of the wall 65, and around which the wall 65 pivots. Depending on the orientation of the first flap 64 and more precisely the orientation of the wall 65, the air stream FS leaving the housing 30 may be oriented selectively in the direction of one or two outlet openings 6, 7 depending on the setpoints from the vehicle occupants.

In another embodiment, the first flap 64 arranged at the level of the air outlet 36 may comprise a first set of flaps 64a and a second set of flaps 64b, the flaps of the first set of flaps 64a pivoting in one direction of rotation, for example clockwise, and the flaps of the second set of flaps 64b pivoting in the opposite direction of rotation, for example anticlockwise, as illustrated in FIG. 6a. It is clear that each set of flaps 64a, 64b is able to pivot between an open position in which each flap offers minimal resistance to the flow of the air stream, and a closed configuration in which the movable flaps by cooperation close the air outlet 36 and thus prevent the air stream FS from flowing via the air outlet 36.

According to the invention, it is also possible to arrange an actuating mechanism allowing movement of each set of flaps 64a, 64b independently of one another. For example, each set of flaps 64a, 64b may comprise a dedicated actuator, or the actuator may comprise a cam path able to move each set of flaps in any configuration. Thus it is possible to orient or not orient the air stream FS leaving the housing 30 towards an air outlet 6, 7. For example, if all flaps of the second set of flaps 64b are in the closed configuration, and the flaps of the first set of flaps 64b are in the open configuration, the air stream FSa leaving the housing 30 is then oriented so as to supply the outlet opening 6 close to the window 9. Similarly, if all flaps of the second set of flaps 64b are in the open configuration, and the flaps of the first set of flaps 64b are in the closed configuration, the air stream FSb leaving the housing 30 is then oriented so as to supply the outlet opening 7 at the armrests. The flaps of each set of flaps 64a, 64b may be connected together via a connecting rod so as to synchronize the pivoting of each flap, wherein the actuator may for example move the connecting rod or move one of the flaps which then drives the connecting rod.

According to another embodiment, the first flap 64 may comprise a sliding door 64c, as illustrated in FIG. 6b, which slides along a U-shaped rail 67 such that the sliding door can orient the air stream towards one air outlet 6, 7 or towards both, or close the air outlet 36 completely.

The first flap 64 is moved by an actuator which is itself controlled by an electronic control unit (ECU) of the vehicle. Usually, the occupant of the vehicle indicates the desired ventilation conditions to the ECU by pressing the control buttons on the dashboard (temperature and air flow rate), and in response the ECU sends a command to the actuator to adapt the air flow according to the setpoints.

According to one embodiment, it is possible to arrange a humidity sensor close to the window 9. If the sensor detects an excessive humidity level (for example misting on the window), it sends a signal to the actuator to position the first flap 64 so as to orient the air flow FS leaving the housing 30 towards the window 9 via the outlet opening 6. The ECU may also send a command to the heating, ventilation and/or air conditioning system of the vehicle so as to supply a second, warm and dry air stream FE which will demist the window 9 better.

According to one embodiment, a second flap 72 may be arranged inside the hollow body 10 in the door 4, between the outlet openings 6, 7, as illustrated in FIG. 7. In other words, the hollow body 10 comprises at least two outlet openings 6, 7, the movable flap 72 being arranged between said outlet openings 6, 7 such that the air stream can be selectively oriented towards at least one of the outlet openings 6, 7. The second flap 72 may also be of the shutter type (as shown in FIG. 7), or of the butterfly, drum or sliding type. The second flap 72 is able to pass from a configuration in which it orients the air stream FS leaving the housing 30 in the direction of the outlet opening 7, to a configuration in which it orients the air stream FS in the direction of the outlet opening 6, and any intermediate position. It is thus possible to design an embodiment in which the second flap 72 prevents the air stream from flowing through any of the outlet openings 6, 7.

Evidently, it is possible to arrange a first flap 64 inside the housing 30, and a second flap 72 inside the hollow body.

According to one embodiment, the housing 30 may also comprise a third flap 74 arranged at the level of the first air inlet 35. The first flap 74 may be of the butterfly, shutter, sliding door or drum type. As illustrated on FIG. 6c, the first flap 74 is here of the sliding type. The third flap 74 comprises a wall or a door 75 on which a rack is arranged. A gearwheel, namely an element with a plurality of teeth, is moved in rotation by an actuator or motor. This pivoting allows the translational movement of the door 75 via the cooperation of the rack and gearwheel. In order to limit the displacement of the door in a restricted or predefined space, the door 75 comprises studs sliding along a rail 76, here U-shaped. Thus depending on the dimensioning of the rail 76, or in other cases the actuator, the third flap 74 is able to at least partially close the first air inlet 35. In other words, the third movable flap 74 is able to pass from an open configuration in which the door 75 offers minimum opposition to the flow of the air stream through the first air inlet 35, to a closed configuration in which the door 75 fully closes the first air inlet 35. Naturally, the third flap 74 is able to adopt any intermediate configuration.

According to one embodiment, the housing 30 may also comprise a fourth flap 78 arranged at the level of the second air inlet 39. The fourth flap 78 may be of the butterfly, shutter or drum type. As illustrated on FIG. 2, the fourth flap 78 is here of the butterfly type. The fourth flap 78 comprises a wall 80 or a door, and a rotation shaft 82, in other words a pin, arranged in the centre of the wall 80. The rotation shaft 82 is moved by an actuator which drives the rotation of the wall 80. In other words, the fourth flap 78 is able to pass from an open configuration in which the wall 80 offers minimum opposition to the flow of the air stream through the second air inlet 39, to a closed configuration in which the wall 80 prevents any flow of an air stream through the second air inlet 39. Naturally, the fourth flap 78 is able to adopt any intermediate configuration.

Of course, the invention is not limited to a specific embodiment. In other words, it is possible to design an embodiment in which the housing comprises the third movable flap 74 and/or the fourth movable flap 78.

The third flap 74 is moved by an actuator which is itself controlled by an electronic control unit (ECU) of the vehicle. The fourth flap 78 is also moved by an actuator which is itself controlled by an electronic control unit (ECU) of the vehicle. Usually, the occupant of the vehicle indicates the desired ventilation conditions to the ECU by pressing the control buttons on the dashboard (temperature and air flow rate), and in response the ECU sends a command to the actuator for each flap 74, 78 so as to adapt the air flow according to the setpoints.

According to the invention, and as illustrated by FIGS. 4 and 5, a third air inlet opening 8 is provided. This additional air inlet opening 8 corresponds to a porous wall also opening into the hollow body 10. More specifically, the additional air inlet opening 8 is disposed on the trim panel 23, such that a first air stream FR from the passenger compartment 5 is drawn into the hollow body 10, then enters the housing 30 through the first air inlet 35 of the housing 30 and then is mixed with the second treated air stream FE in the channel 42. The mixed air stream flows through the air outlet 36 of the housing 30 and is oriented through the hollow body toward the outlet openings 6, 7.

According to the invention, a fifth flap 86 may be arranged at the level of the additional air inlet opening 8. In other words, the fifth flap 86 is able to pass from an open configuration of the air inlet opening 8, in which the air stream passes through the air inlet opening 8 and thus enters the housing 30, wherein another third flap 74 may be arranged at the level of the first air inlet 35 of the housing 30, to a closed position in which the fifth flap 86 closes the additional air inlet opening 8 and the air stream can no longer flow through the additional air inlet opening 8. For this, the door 4 comprises within its structure a recess 88 able to receive the whole of the fifth flap 86. In other words, the fifth flap 86 in its open position and the position retracted into the recess 88.

Still according to the invention, the second flap 78 may be arranged inside the duct 52 as shown on FIG. 2. The duct 52 may comprise stops 84 (FIG. 8) against which the flap 78 may rest and thus close the duct 52, preventing the second air stream FE from flowing through the second air inlet 39.

The principle of the suction of a stream by the flow of another stream is called stream induction, the first air stream FR coming from the passenger compartment then forming a stream induced by a drop in pressure of the second air stream FE coming from the heating, ventilation and/or air conditioning system in the housing 30. The second air stream FE and the first air stream FR that have been mixed then form the air stream FS that is emitted through the one or more outlet openings 6, 7.

In order to ensure better blending of the mixing between the second air stream coming from the HVAC and the first air stream FR coming from the passenger compartment, the hollow body 10 may be equipped with a mixing channel arranged to collect these two streams downstream of the air inlet opening 8 and to guide them as far as the outlet openings 6, 7, with for example one or more flow disruptors disposed in this mixing channel in order to optimize the mixing of the air stream FE with the air stream FR inside the hollow body 10.

The air inlet opening 8 is configured in terms of size, disposition or physical features such that the second air stream FE entering the channel 42 of the housing cannot leave via the air inlet opening 8. The speed of the second air stream FE entering the channel 42 may also help prevent its leaving via the air inlet opening 8.

Without departing from the scope of the invention, a plurality of air inlet openings 8 may be provided. It should be noted that the one or more air inlet openings 8 are situated in a lower part of the door 2. In other words, each air inlet opening 8 is situated closer to the floor than to the roof of the motor vehicle. More specifically, the one or more air inlet openings 8 are situated closer to the lower face of the door 2, or beneath the armrests 63, than the housing 30. Thus, according to the frame of reference defined above, the one or more air inlet openings 8 are disposed beneath the housing 30 along the vertical axis V.

The air inlet opening 8 corresponds in this case to a porous wall able to allow an air stream coming from the passenger compartment to pass through enter the hollow body 10 present in the door 4. The first air stream FR enters the housing 30, optionally by passing through the support 61, through the first air inlet 35.

Naturally, it is possible to design an embodiment in which the housing 30 and/or the door 4 comprise the first flap 64 and/or the second flap 72 and/or the third movable flap 74 and/or the fourth movable flap 78 and/or the fifth movable flap 86.

The invention as has just been described is not limited to the means and configurations exclusively described for a particular exemplary embodiment, and also applies to all combinations of these means or configurations and to equivalents and to any combination of such means or configurations with the equivalents. Similarly, although the invention has been described here according to embodiment variants that each separately implement one type of stream induction technique, it is evident that the techniques presented can be combined without adversely affecting the invention.

1. A housing to be mounted on a motor vehicle door, comprising:
a first air inlet for admitting a first air stream into the housing;
an air outlet;
a chamber, delimited by at least one partition, arranged inside the housing;
a second air inlet for directly admitting a second air stream into the chamber,
the first air inlet, the chamber and the air outlet being fluidically connected; and
at least one movable flap.

2. The housing as claimed in claim 1, wherein a first movable flap is arranged at the level of the air outlet.

3. The housing as claimed in claim 1, wherein the first flap is of the shutter or butterfly type comprising at least one panel and a rotation shaft.

4. The housing as claimed in claim 1, wherein the first flap comprises a first set of flaps and a second set of flaps, the flaps of the first set of flaps pivoting in one direction of rotation and the flaps of the second set of flaps pivoting in the opposite direction of rotation.

5. The housing as claimed in claim 1, wherein the first flap is of the sliding type comprising at least one sliding door inside a rail.

6. The housing as claimed in claim 1, wherein a third movable flap is arranged at the level of the first air inlet.

7. The housing as claimed in claim 6, wherein the third movable flap comprises a sliding door inside a rail.

8. The housing as claimed in claim 1, wherein a fourth movable flap is arranged at the level of the second air inlet.

9. An assembly of a vehicle door, comprising:
a housing support for carrying a housing; and
the housing comprising:
a first air inlet for admitting a first air stream into the housing;
an air outlet,
a chamber, delimited by at least one partition, arranged inside the housing,
a second air inlet for directly admitting a second air stream into the chamber,
the first air inlet, the chamber and the air outlet being fluidically connected, and
at least one movable flap.

10. The assembly as claimed in claim 9, wherein the vehicle door comprises at least one trim panel and a door bodywork together forming the door, said trim panel and the door bodywork defining between them a hollow body via which the air streams may flow, a second movable flap being arranged inside the hollow body.

11. The assembly as claimed in claim 10, wherein the second movable flap is of the shutter or butterfly type comprising at least one panel and a rotation shaft.

12. The assembly as claimed in 10, wherein the hollow body comprises at least two outlet openings, the second movable flap being arranged between said outlet openings such that the air stream can be selectively oriented towards at least one of said outlet openings.

13. An assembly of a vehicle door, comprising:
at least one trim panel; and
a door bodywork, the at least one trim panel and door bodywork together forming the door, and defining between them a hollow body via which an air stream may flow, and
a housing support, for carrying a housing, the housing comprising:
a first air inlet for admitting a first air stream into the housing,
an air outlet,
a chamber, delimited by at least one partition, arranged inside the housing,
a second air inlet for directly admitting a second air stream into the chamber,
the first air inlet, the chamber and the air outlet being fluidically connected,
wherein a movable flap is arranged inside the hollow body.
